(19) United States
(12) Patent Application Publication
(10) Pub. No.: US 2009/0256273 A1
(43) Pub. Date: Oct. 15, 2009

(54) METHOD FOR MAKING LENSES

(75) Inventor: Tai-Cherng Yu, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/253,867

(22) Filed: Oct. 17, 2008

(30) Foreign Application Priority Data
Apr. 9, 2008 (CN) 200810300935.6

(51) Int. Cl. B29D 11/00

(52) U.S. Cl. 264/2.7

(57) ABSTRACT

A method for making a plurality of lenses, includes steps of: providing a transparent substrate; jetting a plurality of first lumps of a first molding material on a first surface of the substrate using a first nozzle; press-molding the first lumps of the first molding material into a plurality of first optical structures using a first mold including a plurality of first molding surfaces corresponding to the first optical structures; jetting a plurality of second lumps of a second molding material on a second surface of the substrate using a second nozzle; press-molding the second lumps of the second molding material into a plurality of second optical structures using a second mold including a plurality of second molding surfaces corresponding to the second optical structures; and dicing the substrate to form a plurality of lenses each with one of the first optical structures and one of the second optical structures.

### BACKGROUND

1. Technical Field

The present invention relates to methods for making lenses, and particularly, to a press-molding method for making a plurality of lenses.

2. Description of Related Art

Lenses, are transparent and usually have concave or convex optical structures formed at opposite sides thereof. The surfaces of the optical structures are called optical surfaces.

Press-molding has been widely used for making large quantities of lenses. Optical surfaces of a lens may be formed at a same time using a press-molding machine having two opposite press-molding molds, or may be formed successively using one or two press-molding molds.

In the above method, a molding material is usually coated on an entire surface of a substrate, then a press-molding mold is applied on the molding material to form a plurality of optical structures. However, in this way, redundancy of the molding material may occur, especially at a periphery of an optical structure.

What is needed, therefore, is a method for making a lens, which can overcome the above shortcomings.

### SUMMARY

A method for making a plurality of lenses, is provided. The method includes steps of: providing a transparent substrate having a first surface and an opposite second surface; jetting a plurality of first lumps of a first molding material on the first surface of the substrate using a first nozzle; press-molding the first lumps of the first molding material into a plurality of first optical structures using a first mold, the first mold including a plurality of first molding surfaces for forming the first optical structures; jetting a plurality of second lumps of a second molding material on the second surface of the substrate using a second nozzle; press-molding the second lumps of the second molding material into a plurality of second optical structures using a second mold, the second mold including a plurality of second molding surfaces for forming the second optical structures; and dicing the substrate into a plurality of lenses each having one of the first optical structures and one of the second optical structures at opposite sides thereof.

Other advantages and novel features of the method will become more apparent from the following detailed description of embodiment when taken in conjunction with the accompanying drawings.

### BRIEF DESCRIPTION OF THE DRAWINGS

Many aspects of the method can be better understood with reference to the following drawings. The components in the drawings are not necessarily drawn to scale, the emphasis instead being placed upon clearly illustrating the principles of the present method. Moreover, in the drawings, like reference numerals designate corresponding parts throughout the several views.

FIG. 1 is an enlarged view of a lens to be formed by one embodiment of present method.

FIG. 2 shows a first mold used to mold the lens of FIG. 1.

FIG. 3 shows a substrate and a plurality of first lumps of a first molding material jetted on the substrate.

FIG. 4 shows press-molding of first optical structures by applying the first mold of FIG. 2 on the substrate of FIG. 3.

FIG. 5 shows separating of the first mold and the substrate with the first optical structures formed thereon.

FIG. 6 shows the substrate with first optical structures and second optical structures formed on opposite sides thereof.

### DETAILED DESCRIPTION OF THE EMBODIMENTS

Embodiments of the present method will now be described in detail below and with reference to the drawings.

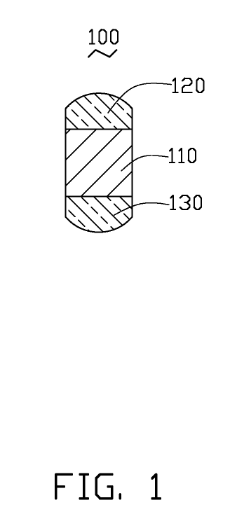

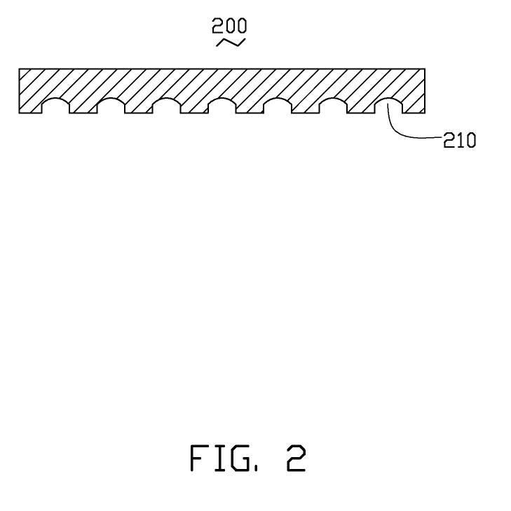

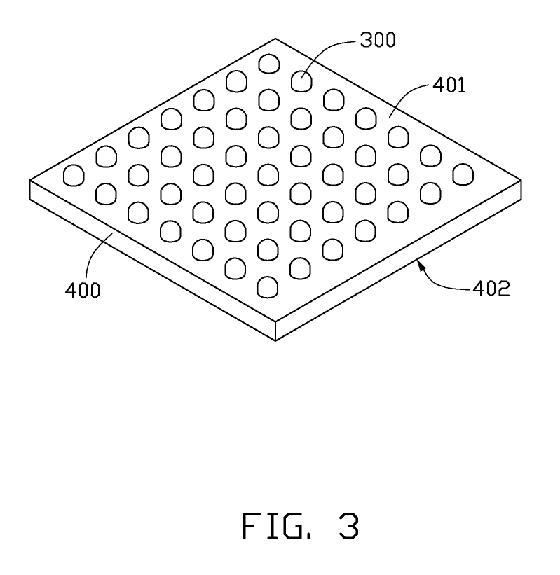

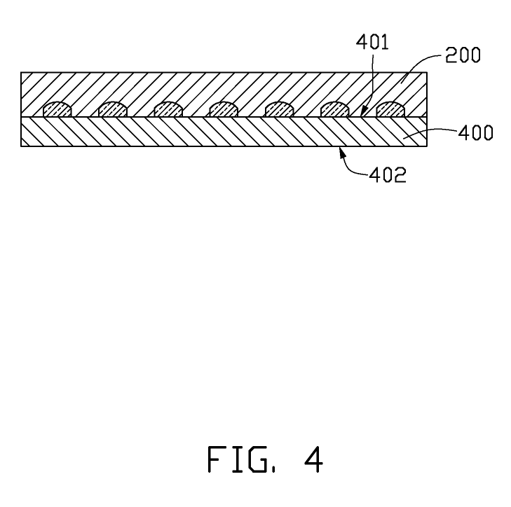

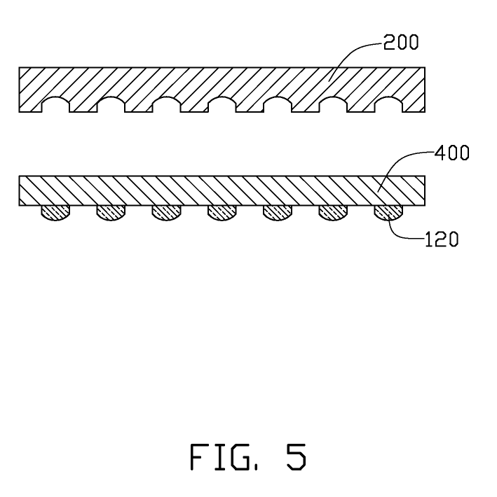

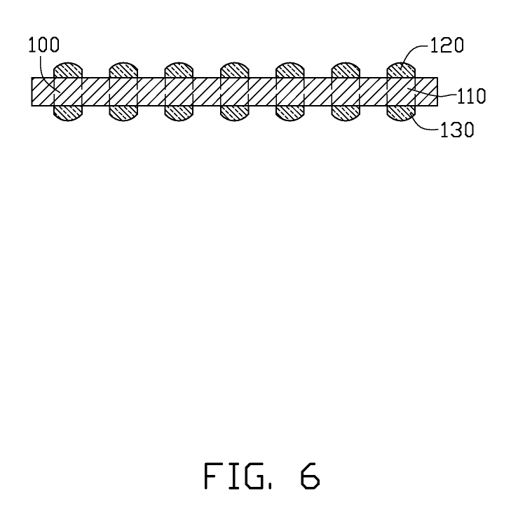

Referring to FIGS. 1 to 6, a method for making a plurality of lenses 100, is provided. The lens 100 includes a substrate layer 110, a first optical structure 120 and an opposite second optical structure 130. The method includes steps in no particular order of:

providing a transparent substrate 400 having a first surface 401 and an opposite second surface 402;

jetting a plurality of first lumps 300 of a first molding material on the first surface 401 of the substrate 400 using a first nozzle (not shown);

press-molding the first lumps 300 of the first molding material into a plurality of first optical structures 120 using a first mold 200, the first mold 200 including a plurality of first molding surfaces 210 for forming the respective first optical structures 120;

jetting a plurality of second lumps (not shown) of a second molding material on the second surface 402 of the substrate 400 using a second nozzle (not shown);

press-molding the second lumps of the second molding material into a plurality of second optical structures 130 using a second mold (not shown), the second mold including a plurality of second molding surfaces for forming the respective second optical structures; and

dicing the substrate 110 into a plurality of the lenses 100 each with the substrate layer 110 and one of the first optical structures 120 and one of the second optical structures 130 at opposite sides of the substrate layer 110.

The transparent substrate 400 may be made of a glass. The first and second molding materials are both transparent, and may be a polymer. The first and second molding materials may subject to melt when applied on the respective first surface 401 and second surface 402 of the substrate 400. The first and second molding materials can be the same or different from each other according to a need of refractive index.

Each of the first and second nozzles preferably has a plurality of spaced jets therein, such that, the plurality of first lumps 300 of the first molding material may be jetted on the first surface 401 of the substrate 400 at a same time, and the plurality of second lumps of the second molding material may be jetted on the second surface 402 of the substrate 400 at a same time. The plurality of the first molding surfaces 210 are formed in an array on the first mold 200, such that the plurality of first lumps 300 of the first molding material are arranged in an array when jetted on the first surface 401 of the substrate 400. By the same method, the plurality of second lumps of the second molding material are arranged in an array when jetted on the second surface of the substrate 400, and each of the second lumps of the second molding material is aligned with one of the respective first lumps 300 of the first molding material.

The first lumps 300 of the first molding material and the second lumps of the second molding material can be sized up beforehand in accordance with the respective sizes of the first and second optical structures, such that redundancy of the first and second molding materials can be reduced.

Each of the first mold 200 and the second mold is transparent to a ultraviolet (UV) light, and the UV light is applied onto the first mold 200 and the second mold to solidify the first and second optical structures during the formation thereof.

It is understood that the above-described embodiments are intended to illustrate rather than limit the invention. Variations may be made to the embodiments and methods without departing from the spirit of the invention. Accordingly, it is appropriate that the appended claims be construed broadly and in a manner consistent with the scope of the invention.

What is claimed is:

1. A method for making a plurality of lenses, comprising:
providing a transparent substrate having a first surface and an opposite second surface;
jetting a plurality of first lumps of a first molding material on the first surface of the substrate using a first nozzle;
press-molding the first lumps of the first molding material into a plurality of first optical structures using a first mold, the first mold comprising a plurality of first molding surfaces for forming the respective first optical structures;
jetting a plurality of second lumps of a second molding material on the second surface of the substrate using a second nozzle; press-molding the second lumps of the second molding material into a plurality of
second optical structures using a second mold, the second mold comprising a plurality of second molding surfaces for forming the second optical structures; and
dicing the substrate into a plurality of lenses each having one of the first optical structures and one of the second optical structures at opposite sides thereof.

2. The method of claim 1, wherein the substrate is made of a glass, and each of the first molding material and the second molding material is a polymer.

3. The method of claim 1, wherein each of the first and second molds is transparent to a given light, and the given light is applied onto the first and second molds to solidify the first and second optical structures.

4. The method of claim 1, wherein the first lumps of the first molding material are arranged in an array, and the second lumps of the second molding material are arranged in an array.

5. The method of claim 1, wherein the first nozzle has a plurality of first jets, and the plurality of first lumps of the first molding material are jetted on the substrate by the first jets.

6. The method of claim 1, wherein the second nozzle has a plurality of second jets, and the plurality of second lumps of the second molding material are jetted on the substrate by the second jets.
